(19) United States
(12) Patent Application Publication
(10) Pub. No.: US 2012/0202115 A1
(43) Pub. Date: Aug. 9, 2012

(54) ANODE ACTIVE MATERIAL, ANODE, BATTERY, AND METHOD OF MANUFACTURING ANODE

(75) Inventors: Keitaro Matsui, Fukushima (JP); Takahiro Shirai, Fukushima (JP); Izaya Okae, Fukushima (JP)

(73) Assignee: SONY CORPORATION, Tokyo (JP)

(21) Appl. No.: 13/449,918

(22) Filed: Apr. 18, 2012

Related U.S. Application Data
(63) Continuation of application No. 12/351,387, filed on Jan. 9, 2009, now abandoned.

(30) Foreign Application Priority Data
Jan. 10, 2008 (JP) 2008-003541

(51) Int. Cl. H01M 4/64; H01M 4/04

(52) U.S. Cl. 429/211; 264/104

(57) ABSTRACT

A battery that has a higher capacity and superior charge and discharge efficiency is provided. The battery includes a cathode, an anode, and an electrolyte. The anode has an anode active material layer provided on an anode current collector, and the anode active material layer contains a spherocrystal graphitized substance of mesophase spherule provided with a fine pore as an anode active material.

### RELATED APPLICATION DATA

This application is a continuation of U.S. application Ser. No. 12/351,387, filed Jan. 9, 2009, the entirety of which is incorporated herein by reference to the extent permitted by law. The present invention contains subject matter related to Japanese Patent Application JP 2008-003541 filed in the Japanese Patent Office on Jan. 10, 2008, the entire contents of which are incorporated herein by reference to the extent permitted by law.

### BACKGROUND OF THE INVENTION

1. Field of the Invention

The present invention relates to an anode active material containing a spherocrystal graphitized substance of mesophase spherule, an anode including the anode active material, a battery, and a method of manufacturing an anode.

2. Description of the Related Art

In recent years, portable devices such as combination cameras, mobile phones, and notebook personal computers have been widely used. Accordingly, as a power source for the portable devices, a small and light-weight secondary batter with a high capacity has been increasingly demanded. As a secondary battery to meet such a demand, a lithium ion secondary battery using a carbon material as an anode active material and using insertion and extraction reaction of lithium is included.

As the carbon material used as an anode active material, a graphite particle with high crystallinity is mainly used. This is because the graphite particle has high electron conductivity and superior discharge performance at a high current, and its potential change associated with discharge is small, and thus the graphite particle is suitably used for the purposes such as constant power discharge. In addition, its real density is high, and thus a high bulk density is easily obtained. Therefore, the graphite particle is advantageous to realize a high capacity. Further, in a material containing silicon, tin or the like that has a higher capacity, intense swollenness and shrinkage occur associated with charge and discharge. Meanwhile, the carbon material has an advantage that such a volume change is extremely small.

To address the high energy density of the lithium ion secondary battery in these years, it has been tried to realize high performance of graphite. However, for a natural graphite particle, a reversible capacity extremely close to the theoretical capacity of graphite (372 mAh/g) has been obtained. Therefore, it has been considered to realize capacity improvement as a battery by filling in a limited volume inside the battery with the graphite particle at high density by, for example, adjusting the particle shape. In general, an artificial graphite particle has an insufficient graphitization degree, and thus the reversible capacity is inferior to that of the natural graphite particle. Therefore, for the artificial graphite particle, to improve the reversible capacity, various considerations such as improving purity of a raw material, setting appropriate graphitization conditions, and adding a catalyst matter promoting graphitization have been made. Lithium ion secondary batteries using a carbon material are disclosed in, for example, Japanese Unexamined Patent Application Publication Nos. 57-208079, 58-93176, 58-192266, 62-90863, 62-122066, 2-66856, 2004-95529, and 2005-44775.

In general, an anode including an anode active material layer containing a carbon material is formed as follows. After a current collector such as a copper foil is coated with paste slurry in which a graphite particle, a binder, a thickening agent and the like are dissolved in water or an organic solvent and dried, compression molding, cutting and the like are performed. The compression molding is an operation necessary to obtain a predetermined thickness and density in the anode active material layer. To realize higher energy density of a battery, it is desirable to further increase the volume density of the anode active material layer. However, if the volume density of the anode active material layer is increased, there is a possibility that in compression molding, the anode active material particle composing the anode active material layer is crushed or dropped.

Therefore, a method to avoid the crushing and the dropping of the anode active material particle associated with press molding by using a mesophase graphite spherule having a higher compression break strength (that is, higher hardness) has been proposed in for example, Japanese Unexamined Patent Application Publication No. 7-272725.

### SUMMARY OF THE INVENTION

In the case where the mesophase graphite spherule having a high hardness is used as in Japanese Unexamined Patent Application Publication No. 7-272725, while the crushing and the dropping of the anode active material particle is able to be prevented in compression molding, load given to the anode current collector as a base on which the anode active material layer is formed is increased. Thus, a crack, a rupture and the like of the anode current collector may be generated particularly in the vicinity of an end of the anode active material layer. Accordingly, it is difficult to increase the press pressure. As a result, the volume density of the anode active material layer may not be improved.

Meanwhile, in the case where a graphite particle having a small particle hardness such as natural graphite, scale-like graphite, and graphite obtained by crushing the scale-like graphite and granulating particles of the scale-like graphite is used as an anode active material, filling at a high density is enabled, and it is advantageous to realizing a higher energy density of the battery. However, when filling such a particle having a small particle hardness at a high density, there is concern as follows. That is, a void in the anode active material layer, in particular, in the vicinity of the surface, is decreased in compression molding, an electrolytic solution is not sufficiently permeated or impregnated, and charge and discharge characteristics at high load and charge characteristics at low temperature are lowered. Further, the scale-like graphite and the graphite obtained by crushing the scale-like graphite and granulating particles of the scale-like graphite have a larger specific surface area than that of the mesophase graphite spherule. Thus, there is a possibility that lowering of a peel strength between the anode current collector and the anode active material layer and lowering of charge and discharge efficiency due to decomposition of the electrolytic solution may be caused.

In view of the foregoing, in the invention, it is desirable to provide a battery that has a higher capacity and superior charge and discharge efficiency. Further, in the invention, it is desirable to provide an anode active material suitable for such a battery, an anode having the anode active material, and a method of manufacturing the anode.

According to an embodiment of the invention, there is provided an anode active material containing a spherocrystal graphitized substance of mesophase spherule provided with a fine pore. The fine pore is herein a concept including all of an air hole existing in the spherocrystal graphitized substance that is blocked from the outer surface, an air hole having one path connecting to the outer surface (that is, a dent section), and a through hole penetrating from an outer surface of one region to an outer surface of the other region (air hole having two or more paths connecting to the outer surface).

According to an embodiment of the invention, there is provided an anode having an anode active material layer provided on an anode current collector. The anode active material layer contains the foregoing anode active material of the embodiment of the invention.

According to an embodiment of the invention, there is provided a battery including a cathode, the foregoing anode of the embodiment of the invention, and an electrolyte.

In the anode active material, the anode, and the battery of the embodiments of the invention, the spherocrystal graphitized substance of mesophase spherule provided with the fine pore is contained. Therefore, when press-molded, the fine pore is crushed and thereby having the hardness at the degree with which the anode current collector is not damaged, and a space into which an electrolytic solution is sufficiently permeated is secured. Further, the spherocrystal graphitized substance of mesophase spherule has a smaller specific surface area than that of natural graphite, scale-like graphite, and graphite obtained by crushing and increasing the number of particles of the natural graphite or the scale-like graphite. Therefore, the spherocrystal graphitized substance of mesophase spherule is advantageous to improve peel strength and charge and discharge efficiency.

According to an embodiment of the invention, there is provided a method of manufacturing an anode including the steps of: preparing an anode current collector, and then forming an anode active material layer containing a spherocrystal graphitized substance of mesophase spherule provided with a fine pore on the anode current collector; and press-molding the anode active material layer so that a volume density of the anode active material layer is in the range from 1.50 g/cm³ to 2.26 g/cm³, both inclusive.

According to the anode active material of the embodiment of the invention, the spherocrystal graphitized substance of mesophase spherule provided with the fine pore is contained. Therefore, while hardness is prevented from being increased, a space into which an electrolytic solution is sufficiently permeated is secured even when press-molded at a high press pressure.

According to the anode of the embodiment of the invention, the anode active material layer including the foregoing anode active material of the embodiment of the invention is included. Therefore, the volume density of the anode active material layer is able to be improved relatively easily, and the discharge capacity is able to be improved. Meanwhile, the anode active material layer is able to secure an appropriate void. Therefore, in the case where the anode is used for an electrochemical device such as the battery of the embodiment of the invention together with an electrolyte, the electrolyte is sufficiently permeated into the anode active material layer, and superior charge and discharge characteristics are exercised.

According to the method of manufacturing an anode of the embodiment of the invention, the anode active material layer having a high volume density and a high discharge capacity is able to be easily formed without damaging the anode current collector.

Other and further objects, features and advantages of the invention will appear more fully from the following description.

### BRIEF DESCRIPTION OF THE DRAWINGS

FIG. 1 is a cross sectional view illustrating a structure of a first battery according to an embodiment of the invention;

FIG. 2 is a cross sectional view illustrating an enlarged part of the spirally wound electrode body in the first battery illustrated in FIG. 1;

FIG. 3 is an exploded perspective view illustrating a structure of a second battery according to the embodiment of the invention;

FIG. 4 is a cross sectional view illustrating a structure taken along line IV-IV of the spirally wound electrode body illustrated in FIG. 3;

FIG. 5 is a cross sectional view illustrating an enlarged part of the spirally wound electrode body illustrated in FIG. 4;

FIG. 6 is a cross sectional view illustrating a structure of a third battery according to the embodiment of the invention; and

FIG. 7 is a cross sectional view illustrating a structure of a test cell used in examples of the invention.

### DETAILED DESCRIPTION OF THE PREFERRED EMBODIMENT

An embodiment of the invention will be hereinafter described in detail with reference to the drawings.

### First Battery

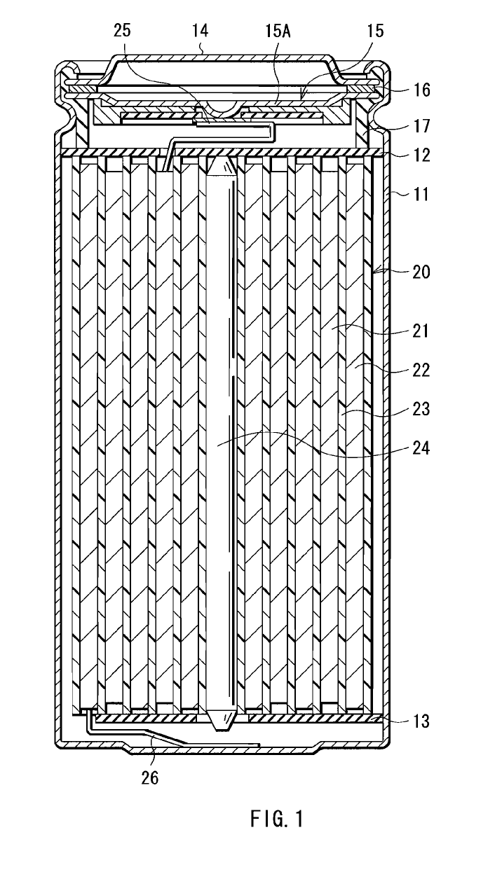

FIG. 1 illustrates a cross sectional structure of a secondary battery according to an embodiment of the invention. The battery is, for example, a lithium ion secondary battery in which the anode capacity is expressed by a capacity based on insertion and extraction of lithium as an electrode reactant.

The secondary battery is a so-called cylinder-type battery, and has a spirally wound electrode body 20 in which a strip-shaped cathode 21 and a strip-shaped anode 22 are spirally wound with a separator 23 in between inside a battery can 11 in the shape of an approximately hollow cylinder. The battery can 11 is made of, for example, iron (Fe) plated by nickel (Ni). One end of the battery can 11 is closed, and the other end of the battery can 11 is opened. Inside the battery can 11, a pair of insulating plates 12 and 13 is respectively arranged perpendicular to the spirally wound periphery face so that the spirally wound electrode body 20 is sandwiched between the insulating plates 12 and 13.

At the open end of the battery can 11, a battery cover 14, and a safety valve mechanism 15 and a PTC (Positive Temperature Coefficient) device 16 provided inside the battery cover 14 are attached by being caulked with a gasket 17. Inside of the battery can 11 is thereby hermetically sealed. The battery cover 14 is made of, for example, a material similar to that of the battery can 11. The safety valve mechanism 15 is electrically connected to the battery cover 14 with the PTC device 16 in between. If the internal pressure of the battery becomes a certain level or more by internal short circuit, external heating or the like, a disk plate 15A flips to cut the electrical connection between the battery cover 14 and the spirally wound electrode body 20. When temperature rises, the PTC device 16 limits a current by increasing the resistance value to prevent abnormal heat generation by a large current. The gasket 17 is made of, for example, an insulating material and its surface is coated with asphalt.

For example, a center pin 24 is inserted in the center of the spirally wound electrode body 20. A cathode lead 25 made of aluminum (Al) or the like is connected to the cathode 21 of the spirally wound electrode body 20. An anode lead 26 made of nickel or the like is connected to the anode 22. The cathode lead 25 is electrically connected to the battery cover 14 by being welded to the safety valve mechanism 15. The anode lead 26 is welded and electrically connected to the battery can 11.

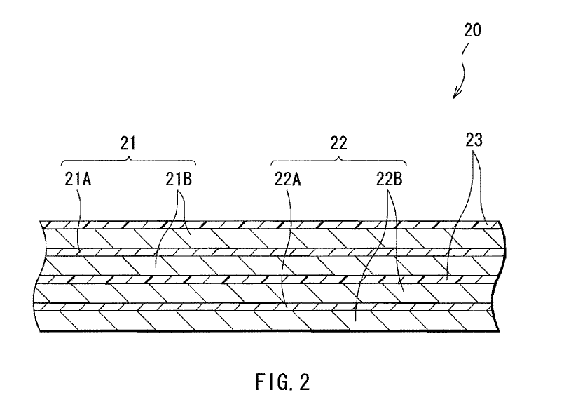

FIG. 2 illustrates an enlarged part of the spirally wound electrode body 20 illustrated in FIG. 1. The cathode 21 has, for example, a structure in which a cathode active material layer 21B is provided on the both faces of a cathode current collector 21A. Though not illustrated, the cathode active material layer 21B may be provided on only a single face of the cathode current collector 21A. The cathode current collector 21A is made of, for example, a metal material such as aluminum, nickel, and stainless. The cathode current collector 21A is, for example, in a state of a foil, a net, or a lath.

The cathode active material layer 21B contains as a cathode active material, one or more cathode materials capable of inserting and extracting lithium as an electrode reactant.

As such a cathode material, for example, a lithium oxide, a lithium sulfide, an interlayer compound containing lithium, or a lithium-containing compound such as a lithium phosphate compound is appropriate. Two or more thereof may be used by mixture. Specially, a complex oxide containing lithium and a transition metal element or a phosphate compound containing lithium and a transition metal element is preferable. In particular, as a transition metal element, a compound containing at least one selected from the group consisting of cobalt (Co), nickel, manganese (Mn), iron, aluminum, vanadium (V), and titanium (Ti) is preferable. The chemical formula thereof is expressed by, for example, LiₓMIO₂ or Li_{y}MIIPO₄. In the formula, MI and MII represent one or more transition metal elements. Values of x and y vary according to charge and discharge states of the battery, and are generally in the range of 0.05≦x≦1.10 and 0.05≦y≦1.10.

The specific examples of the complex oxide containing lithium and a transition metal element include, a lithium-cobalt complex oxide (LiₓCoO₂), a lithium-nickel complex oxide (LiₓNiO₂), a lithium-nickel-cobalt complex oxide (LiₓNi_{(1-z)}CO_{z}O₂ (z<1)), a lithium-nickel-cobalt-manganese complex oxide (LiₓNi_{(1-v-w)}CoᵥMn_{w}O₂ (v+w<1)), lithium-manganese complex oxide having a spinel type structure (LiMn₂O₄) and the like. The specific example of the phosphate compound containing lithium and a transition metal element includes, for example, lithium-iron phosphate compound (LiFePO₄), a lithium-iron-manganese phosphate compound (LiFe₁₋ᵤMnᵤPO₄ (u<1)) and the like.

The cathode material capable of inserting and extracting lithium further includes other metal compound or a polymer compound. Examples of other metal compound include an oxide such as titanium oxide, vanadium oxide, and manganese dioxide; and a disulfide such as titanium disulfide and molybdenum disulfide. Examples of the polymer compound include polyaniline, polythiophene and the like.

The cathode active material layer 21B may contain an electrical conductor or a binder if necessary. The electrical conductor includes, for example, a carbon material such as graphite, carbon black, and Ketjen black. One thereof is used singly, or two or more thereof are used by mixture. Further, in addition to the carbon material, a metal material, a conductive polymer material or the like may be used, as long as the material has electrical conductivity. Examples of the binder include a synthetic rubber such as styrene butadiene rubber, fluorinated rubber, and ethylene propylene diene rubber, or a polymer material such as polyvinylidene fluoride. One thereof is used singly, or two or more thereof are used by mixture.

The anode 22 has, for example, a structure in which an anode active material layer 22B is provided on the both faces of an anode current collector 22A. Though not illustrated, the anode active material layer 22B may be provided on only a single face of the anode current collector 22A. The anode current collector 22A is desirably made of, for example, a metal material having favorable electrochemical stability, favorable electric conductivity, and favorable mechanical strength. The metal material includes, for example, copper, nickel, or stainless steel. In particular, copper having superior electric conductivity is preferable. The anode current collector 22A is, for example, in a state of a foil, a net, or a lath.

The anode active material layer 22B preferably has a volume density in the range from 1.50 g/cm³ to 2.26 g/cm³, both inclusive. In the case where the thickness of the anode active material layer 22B and the composition ratio of the material composing the anode active material layer 22B are constant, by increasing the volume density of the anode active material layer 22B, the filling amount of the anode active material is able to be increased, and the capacity is able to be increased. Further, in this case, since an void inside the anode active material layer 22B is appropriately decreased, contact characteristics between each spherocrystal graphitized substance of mesophase spherule described later (hereinafter referred to as mesophase graphite spherule) are improved, the electron conductivity is improved, and the load characteristics are able to be improved. However, if the volume density of the anode active material layer 22B is excessively increased, the void is decreased and permeability of the electrolytic solution is lowered. Thus, to secure a diffusion path of lithium and prevent lowering of the charge and discharge characteristics, the volume density is desirably 2.26 g/cm³ or less.

The anode active material layer 22B contains as an anode active material, an anode material capable of inserting and extracting lithium as an electrode reactant. The anode active material layer 22B may contain, for example, an electrical conductor and a binder similar to those of the cathode active material layer 21B if necessary.

Such an anode material is formed from the mesophase graphite spherule provided therein with a fine pore. Since the mesophase graphite spherule has therein the fine pore, the ratio of the outer surface area to the entire surface area is, for example, in the range from 10% to 50%, both inclusive. Such a mesophase graphite spherule has a smaller compression break strength than that of the existing mesophase graphite spherule having no fine pore. That is, the mesophase graphite spherule is able to be compression-molded so that a preferable volume density (1.50 g/cm³ or more and 2.26 g/cm³ or less) is obtained by a smaller press pressure than that of the existing mesophase graphite spherule. In particular, the mesophase graphite spherule in which the ratio of the outer surface area to the entire surface area is in the range from 15% to 27%, both inclusive is able to be compression-molded so that the foregoing preferable volume density is obtained by a still smaller press pressure. Therefore, since the anode active material layer 22B contains the foregoing mesophase graphite spherule as an anode active material, the anode active material layer 22B has an appropriate void to become a lithium diffusion path and has a high capacity.

The entire surface area and the outer surface area of the mesophase graphite spherule are determined by performing nitrogen absorption measurement and as plot analysis. The nitrogen absorption measurement is, as generally known, performed to obtain an adsorption isotherm and a desorption isotherm that reflect the size and the structure of a fine pore of a measurement target sample in the process of absorbing nitrogen into the measurement target object and desorbing nitrogen from the measurement target object at temperature of 77K. According to IUPAC (International Union of Pure and Applied Chemistry), fine pore types of measurement target samples are categorized into a micro pore with a diameter of 2 nm or less, a meso pore with a diameter of 2 nm or more and 50 nm or less, and a macro pore with a diameter of 50 nm or more according to the size (diameter size).

The adsorption isotherm obtained by the nitrogen absorption measurement is analyzed by using the as plot analysis as shown in “Latest carbon material experimental technology (physical property and material evaluation version),” edited by Carbon Society of Japan, Sipec Co., pp. 1-7 (2003) and “Absorption of nitrogen by porous and non-porous carbons,” P. J. M. Carrott, R. A. Roberts, and K. S. W. Sing, Carbon, 25 (1987), 59-68. Thereby, the entire surface area and the outer surface area of the mesophase graphite spherule as the measurement target sample are able to be precisely determined.

The entire surface area determined by the as plot analysis represents the total sum of the internal fine pore surface area and the outer surface area in the mesophase graphite spherule. The outer surface area determined by the as plot analysis represents the surface area obtained by excluding the surface area of a micro pore from the foregoing entire surface area, that is, represents the total sum of the surface area of a meso pore, the surface area of a macro pore, and the surface area of a flat plane of the mesophase graphite spherule. However, in the case of the mesophase graphite spherule, the surface area of the flat plane is extremely smaller than the surface areas of the meso pore and the macro pore, and thus is ignorable.

By determining the ratio of the outer surface area to the entire surface area described above, the ratio of the surface area of the fine pores other than the micro pore, that is, meso pore and macro pore, to the entire surface area in the mesophase graphite spherule is able to be represented.

In the mesophase graphite spherule, a specific surface area determined by BET method based on nitrogen absorption measurement is desirably in the range from 0.1 m²/g to 5 m²/g, both inclusive, and is particularly desirably in the range from 0.3 m²/g to 2.0 m²/g, both inclusive. In the case where the specific surface area is 5.0 m²/g or less, in the time of charge and discharge, the mesophase graphite spherule is stably retained on the anode current collector 22A with a binder attached to the surface thereof in between, and battery characteristics such as a discharge capacity are favorably exercised. Further, if the specific surface area is 0.1 m²/g or more, favorable battery characteristics are obtained without lowering interlayer insertion reactivity of lithium to the mesophase graphite spherule.

Further, in the mesophase graphite spherule, to secure the specific surface area in the foregoing given range, the median diameter (D₅₀) by laser diffractive particle size distribution meter is desirably in the range from 5 μm to 50 μm, both inclusive. In particular, the median diameter (D₅₀) is preferably in the range from 10 μm to 35 μm, both inclusive, since the specific surface area in the foregoing given range is more easily obtained.

Furthermore, in the mesophase graphite spherule, the lattice spacing d₀₀₂ in the C-axis direction calculated by X-ray wide angle diffraction method is desirably in the range from 0.3354 nm to 0.3370 nm, both inclusive, in particular, in the range from 0.3354 nm to 0.3360 nm, both inclusive, and the crystallite size Lc in the C-axis direction is desirably 80 nm or more, in particular, 100 nm or more. The lattice spacing d₀₀₂ and the crystallite size Lc in the C-axis direction are determined, for example, as follows. That is, a mixture in which about 20 wt % of high purity silicon powder is added to the mesophase graphite spherule is filled in a sample cell, a diffraction line is obtained by reflective diffractometer method with the use of, as a radiation source, CuKα ray that has been changed into monochromatic ray by a graphite monochrometer by using a certain X-ray diffracting device (for example, RIN2000 X-ray diffracting device of Rigaku Corporation), and thereby determining the lattice spacing d₀₀₂ and the crystallite size Lc in the C-axis direction from the diffraction line based on JSPS (Japan Society for the Promotion of Science) Law.

Moreover, in the mesophase graphite spherule, raman spectrum using argon ion laser light satisfies the following condition expression:

0.05≦B/A≦0.2

where A is an intensity of a peak observed in the range from 1570 cm⁻¹ to 1620 cm⁻¹, both inclusive, and B is an intensity of a peak observed in the range from 1350 cm⁻¹ to 1370 cm⁻¹, both inclusive.

The raman spectrum is measured by putting the mesophase graphite spherule on a glass cell, and using a raman spectrometer (for example, Ramanscope of RENISHAW) with the use of argon ion laser light with a wavelength λ of 514.5 nm.

When the mesophase graphite spherule has the foregoing structure, a high volume density and favorable charge and discharge characteristics are more easily realized.

The separator 23 separates the cathode 21 from the anode 22, prevents current short circuit due to contact of both electrodes, and passes lithium ions. The separator 23 is made of, for example, a porous film made of a synthetic resin such as polytetrafluoroethylene, polypropylene, and polyethylene, or a porous film made of an inorganic material such as a ceramic nonwoven cloth. The separator 23 may have a structure in which two or more of the foregoing porous films are layered. Specially, the porous film made of polyolefin is preferable, since such a film has a superior short circuit preventive effect and is able to improve battery safety by shutdown effect. In particular, polyethylene is preferable as a material composing the separator 23, since polyethylene provides shutdown effect in the range from 100 deg C. to 160 deg C., both inclusive and has superior electrochemical stability. Further, polypropylene is also preferable. In addition, as long as chemical stability is secured, a resin formed by copolymerizing or blending with polyethylene or polypropylene may be used.

The thickness of the separator 23 is preferably in the range from 10 μm to 50 μm, both inclusive. If the thickness of the separator 23 is under 10 μm, short circuit may be generated. Meanwhile, if the thickness of the separator 23 exceeds 50 μm, lowering of ion permeability and lowering of battery volume efficiency may be generated.

The aperture ratio of the separator 23 is preferably in the range from 30% to 70%, both inclusive. If the aperture ratio of the separator 23 is under 30%, ion permeability may be lowered. Meanwhile, if the aperture ratio of the separator 23 exceeds 70%, the strength is lowered, and thus insulative function is damaged, and short circuit may be generated.

An electrolytic solution is impregnated in the separator 23. The electrolytic solution contains, for example, a solvent and an electrolyte salt dissolved in the solvent.

Example of the solvent includes an ambient temperature molten salt such as ethylene carbonate, propylene carbonate, butylene carbonate, vinylene carbonate, dimethyl carbonate, diethyl carbonate, ethyl methyl carbonate, 4-fluoro-1,3-dioxolane-2-one, γ-butyrolactone, γ-valerolactone, 1,2-dimethoxyethane, tetrahydrofuran, 2-methyltetrahydrofuran, 1,3-dioxolane, 4-methyl-1,3-dioxolane, methyl acetate, methylpropionate, ethylpropionate, acetonitrile, glutaronitrile, adiponitrile, methoxyacetonitrile, 3-methoxypropionitrile, N,N-dimethylformamide, N-methylpyrrolidinone, N-methyloxazolidinone, nitromethane, nitroethane, sulfolane, dimethyl sulfoxide, trimethyl phosphate, triethyl phosphate, ethylene sulfite, and bistrifluoromethylsulfonylimidetrimethylhexylammonium. Specially, ethylene carbonate, propylene carbonate, vinylene carbonate, 4-fluoro-1,3-dioxolane-2-one, dimethyl carbonate, ethyl methyl carbonate, or ethylene sulfite is preferable, since superior charge and discharge capacity characteristics and superior charge and discharge cycle characteristics are thereby able to be obtained. One of the solvents may be used singly, or a plurality thereof may be used by mixture.

As the electrolyte salt, for example, lithium hexafluorophosphate (LiPF₆), lithium bis(pentafluoroethanesulfonyl)imide (Li(C₂F₅SO₂)₂N), lithium perchlorate (LiClO₄), lithium hexafluoroarsenate (LiAsF₆), lithium tetrafluoroborate (LiBF₄), lithium trifluoromethanesulfonate (LiSO₃CF₃), lithium bis(trifluoromethanesulfonyl)imide (Li(CF₃SO₂)₂N), lithium tris(trifluoromethanesulfonyl)methyl (LiC(SO₂CF₃)₃), lithium chloride (LiCl), lithium bromide (LiBr), lithium tetraphenyl borate (LiB(C₆H₅)₄), lithium methanesulfonate (LiCH₃SO₃), lithium trifluoromethanesulfonate (LiCF₃SO₃), lithium bis(trifluoromethanesulfonyl)imide (LiN(SO₂CF₃)₂), lithium aluminate tetrachloride (LiAlCl₄), lithium hexafluorosilicate (LiSiF₆), lithium difluorooxalateborate (LiBF₂(Oₓ)), or lithium bisoxalateborate (LiBOB) is included. Specially, LiPF₆ is preferable, since thereby high ion conductivity is able to be obtained, and the cycle characteristics are able to be improved. One of the electrolyte salts may be used singly, or a plurality thereof may be used by mixture. The electrolyte salt is dissolved in the foregoing solvent at a concentration in the range from 0.1 mol/dm³ to 3.0 mol/dm³, both inclusive, preferably in the range from 0.5 mol/dm³ to 1.5 mol/dm³, both inclusive.

The secondary battery may be manufactured, for example, as follows.

First, a cathode active material, an electrical conductor, and a binder are mixed to prepare a cathode mixture, which is dispersed in a solvent such as N-methyl-2-pyrrolidone to obtain paste cathode mixture slurry. Subsequently, the cathode current collector 21A is coated with the cathode mixture slurry, and the solvent is dried. After that, the resultant is compression-molded by a rolling press machine or the like to form the cathode active material layer 21B. Accordingly, the cathode 21 is formed. Otherwise, the cathode active material layer 21B may be formed by bonding the cathode mixture to the cathode current collector 21A.

Further, the foregoing graphite particle and a binder are mixed to prepare an anode mixture, which is dispersed in a solvent such as N-methyl-2-pyrrolidone to obtain paste anode mixture slurry. Subsequently, the anode current collector 22A is coated with the anode mixture slurry, and the solvent is dried. After that, the resultant is compression-molded by a rolling press machine or the like to form the anode active material layer 22B so that the volume density is in the range from 1.50 g/cm³ to 2.26 g/cm³, both inclusive. Accordingly, the anode 22 is formed.

Next, the cathode lead 25 is attached to the cathode current collector 21A by welding or the like, and the anode lead 26 is attached to the anode current collector 22A by welding or the like. After that, the cathode 21 and the anode 22 are spirally wound with the separator 23 in between. An end of the cathode lead 25 is welded to the safety valve mechanism 15, and an end of the anode lead 26 is welded to the battery can 11. The spirally wound cathode 21 and the spirally wound anode 22 are sandwiched between the pair of insulating plates 12 and 13, and contained in the battery can 11. After the cathode 21 and the anode 22 are contained in the battery can 11, the electrolytic solution is injected into the battery can 11 and impregnated in the separator 23. After that, at the open end of the battery can 11, the battery cover 14, the safety valve mechanism 15, and the PTC device 16 are fixed by being caulked with the gasket 17. The secondary battery illustrated in FIG. 1 is thereby completed.

In the secondary battery, when charged, for example, lithium ions are extracted from the cathode active material layer 21B and inserted in the anode active material layer 22B through the electrolytic solution. When discharged, for example, lithium ions are extracted from the anode active material layer 22B, and inserted in the cathode active material layer 21B through the electrolytic solution.

In this embodiment, the anode active material in the anode active material layer 22B contains the mesophase graphite spherule having the fine pore, and thereby the compression break strength is decreased. Thus, the volume density is increased by compression molding, the total amount of the active material contained in the battery is increased, and thereby the capacity is able to be improved. At this time, even with a lower press pressure, the volume density of the anode active material layer 22B is able to be increased. Thus, in the stage of forming the anode 22, an excessive stress is not given to the anode current collector 22A. Accordingly, there is no possibility to generate a dent, a crack, an opening, or a fracture due to stress generation originated from the mesophase graphite spherule. If the ratio of the outer surface area to the entire surface area in the mesophase graphite spherule is under 10%, the break compression strength is not sufficiently decreased, and there is a possibility to generate a dent, a crack, an opening, or a fracture in the anode current collector 22A. However, in this embodiment, the foregoing ratio is 10% or more, and thus there is no possibility as above.

Further, in this embodiment, even in the case where the volume density is increased by compression molding, the appropriate void is formed in the anode active material layer 22B. Thus, a lithium diffusion path is able to be sufficiently secured in the anode active material layer 22B, and superior charge and discharge characteristics are able to be obtained. Further, the charge and discharge characteristics are also improved by the improved electron conductivity due to the improved contact characteristics of the first and the second graphite particles. If the ratio of the outer surface area to the entire surface area in the mesophase graphite spherule exceeds 50%, the surface area originated from the meso pore and the macro pore becomes excessively large, and starting points of break and deformation of the mesophase graphite spherule itself exist excessively, and thus the compression break strength becomes extremely low. As a result, in press molding, a press pressure applied to the anode active material layer 22B becomes easily uneven, the vicinity of the surface layer is crushed, and it is difficult to secure a sufficient lithium diffusion path. However, in this embodiment, the foregoing ratio is 50% or less, and thus there is no possibility as above.

### Second Battery

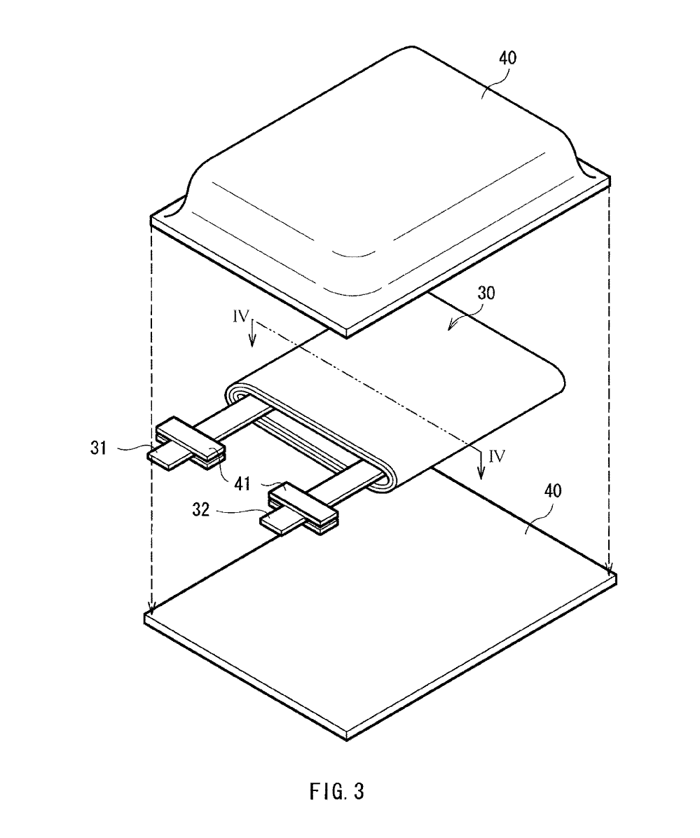

FIG. 3 illustrates an exploded perspective structure of a second battery. In the battery, a spirally wound electrode body 30 to which a cathode lead 31 and an anode lead 32 are attached is contained in a film package member 40. The battery structure using the film package member 40 is called laminated film type.

The cathode lead 31 and the anode lead 32 are, for example, respectively derived in the same direction from inside to outside of the package member 40. The cathode lead 31 is made of, for example, a metal material such as aluminum, and the anode lead 32 is made of, for example, a metal material such as copper, nickel, and stainless. The respective metal materials composing the cathode lead 31 and the anode lead 32 are in the shape of a thin plate or mesh.

The package member 40 is made of a rectangular aluminum laminated film in which, for example, a nylon film, an aluminum foil, and a polyethylene film are bonded together in this order. In the package member 40, for example, the polyethylene film and the spirally wound electrode body 30 are opposed to each other, and the respective outer edges are contacted to each other by fusion bonding or an adhesive. Adhesive films 41 to protect from entering of outside air are inserted between the package member 40 and the cathode lead 31 and the anode lead 32. The adhesive film 41 is made of a material having contact characteristics to the cathode lead 31 and the anode lead 32, for example, is made of a polyolefin resin such as polyethylene, polypropylene, modified polyethylene, and modified polypropylene.

The package member 40 may be made of a laminated film having other structure, a polymer film made of polypropylene or the like, or a metal film, instead of the foregoing 3-layer aluminum laminated film.

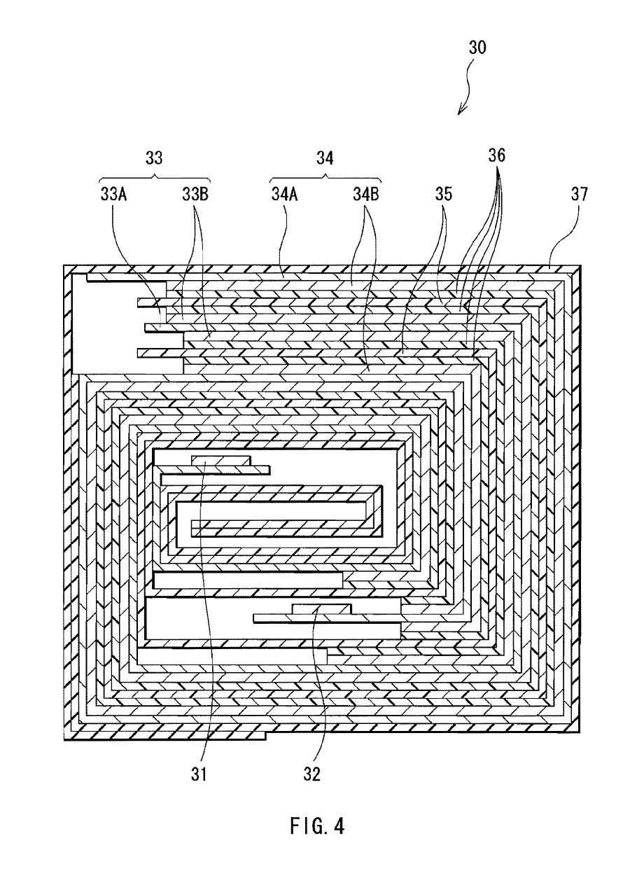

FIG. 4 illustrates a cross sectional structure taken along line IV-IV of the spirally wound electrode body 30 illustrated in FIG. 3. In the spirally wound electrode body 30, a cathode 33 and an anode 34 are layered with a separator 35 and an electrolyte 36 in between and then spirally wound. The outermost periphery thereof is protected by a protective tape 37. Though FIG. 4 illustrates the simplified spirally wound electrode body 30, the spirally wound electrode body 30 actually has a flat (oval) cross section.

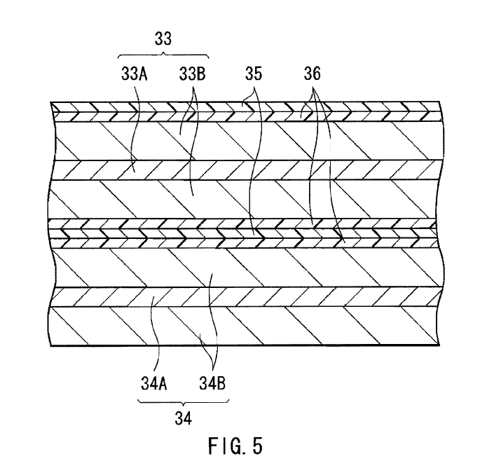

FIG. 5 illustrates an enlarged part of the spirally wound electrode body 30 illustrated in FIG. 4. In the cathode 33, a cathode active material layer 33B is provided on the both faces of a cathode current collector 33A. The anode 34 has, for example, a structure similar to that of the anode illustrated in FIG. 1, that is, a structure in which an anode active material layer 34B is provided on the both faces of an anode current collector 34A. Structures of the cathode current collector 33A, the cathode active material layer 33B, the anode current collector 34A, the anode active material layer 34B, and the separator 35 are respectively similar to those of the cathode current collector 21A, the cathode active material layer 21B, the anode current collector 22A, the anode active material layer 22B, and the separator 23 in the foregoing first battery.

The electrolyte 36 is so-called gelatinous, containing an electrolytic solution and a polymer compound that holds the electrolytic solution. The gel electrolyte is preferable, since a high ion conductivity (for example, 1 mS/cm or more at room temperature) is able to be thereby obtained, and leakage of the battery is able to be thereby prevented.

As the polymer compound, for example, an ether polymer compound such as polyethylene oxide and a cross-linked body containing polyethylene oxide, an ester polymer compound such as polymethacrylate or an acrylate polymer compound, or a polymer of vinylidene fluoride such as polyvinylidene fluoride and a copolymer of vinylidene fluoride and hexafluoropropylene is included. One thereof may be used singly, or a plurality thereof may be used by mixture. In particular, in terms of redox stability, the fluorinated polymer compound such as the polymer of vinylidene fluoride or the like is preferably used. The additive amount of the polymer compound in the electrolytic solution varies according to compatibility therebetween, but is preferably in the range from 5 wt % to 50 wt %, both inclusive. Further, in such a polymer compound, for example, it is desirable that the number average molecular weight is in the range from 5.0×10⁵ to 7.0×10⁵ or the weight average molecular weight is in the range from 2.1×10⁵ to 3.1×10⁵, and the inherent viscosity is in the range from 0.17 (dm³/g) to 0.21 (dm³/g).

The composition of the electrolytic solution is similar to the composition of the electrolytic solution in the foregoing first battery. However, the solvent in this case means a wide concept including not only the liquid solvent but also a solvent having ion conductivity capable of dissociating the electrolyte salt. Therefore, in the case where the polymer compound having ion conductivity is used, the polymer compound is also included in the solvent.

Instead of the electrolyte 36 in which the electrolytic solution is held by the polymer compound, the electrolytic solution may be directly used. In this case, the electrolytic solution is impregnated in the separator 35.

The secondary battery is able to be manufactured, for example, by the following three types of manufacturing methods.

In the first manufacturing method, first, the cathode 33 is formed by forming the cathode active material layer 33B on the both faces of the cathode current collector 33A by a procedure similar to that of the manufacturing method of the first battery. Further, the anode 34 is formed by forming the anode active material layer 34B on the both faces of the anode current collector 34A by a procedure similar to that of the manufacturing method of the first battery.

Subsequently, a precursor solution containing an electrolytic solution, a polymer compound, and a solvent is prepared. After the cathode 33 and the anode 34 are coated with the precursor solution, the solvent is volatilized to form the gel electrolyte 36. Subsequently, the cathode lead 31 and the anode lead 32 are respectively attached to the cathode current collector 33A and the anode current collector 34A. Next, the cathode 33 and the anode 34 formed with the electrolyte 36 are layered with the separator 35 in between to obtain a laminated body. After that, the laminated body is spirally wound in the longitudinal direction, the protective tape 37 is adhered to the outermost periphery thereof to form the spirally wound electrode body 30. Subsequently, for example, after the spirally wound electrode body 30 is sandwiched between 2 pieces of the film package members 40, outer edges of the package members 40 are contacted by thermal fusion bonding or the like to enclose the spirally wound electrode body 30. At this time, the adhesive films 41 are inserted between the cathode lead 31, the anode lead 32 and the package member 40. Thereby, the secondary battery illustrated in FIG. 3 to FIG. 5 is completed.

In the second manufacturing method, first, the cathode lead 31 and the anode lead 32 are respectively attached to the cathode 33 and the anode 34. After that, the cathode 33 and the anode 34 are layered with the separator 35 in between and spirally wound. The protective tape 37 is adhered to the outermost periphery thereof, and thereby a spirally wound body as a precursor of the spirally wound electrode body 30 is formed. Subsequently, after the spirally wound body is sandwiched between 2 pieces of the film package members 40, the outermost peripheries except for one side are thermally fusion-bonded to obtain a pouched state, and the spirally wound body is contained in the pouch-like package member 40. Subsequently, a composition of matter for electrolyte containing an electrolytic solution, a monomer as a raw material for the polymer compound, a polymerization initiator, and if necessary other material such as a polymerization inhibitor is prepared, which is injected into the pouch-like package member 40. After that, the opening of the package member 40 is hermetically sealed by thermal fusion bonding or the like. Finally, the monomer is thermally polymerized to obtain a polymer compound. Thereby, the gel electrolyte 36 is formed. Accordingly, the secondary battery is completed.

In the third manufacturing method, the spirally wound body is formed and contained in the pouch-like package member 40 in the same manner as that of the foregoing first manufacturing method, except that the separator 35 with the both faces coated with a polymer compound is used. As the polymer compound with which the separator 35 is coated, for example, a polymer containing vinylidene fluoride as a component, that is, a homopolymer, a copolymer, a multicomponent copolymer and the like are included. Specifically, polyvinylidene fluoride, a binary copolymer containing vinylidene fluoride and hexafluoropropylene as a component, a ternary copolymer containing vinylidene fluoride, hexafluoropropylene, and chlorotrifluoroethylene as a component and the like are included. As a polymer compound, in addition to the foregoing polymer containing vinylidene fluoride as a component, another one or more polymer compounds may be used. Subsequently, an electrolytic solution is prepared and injected into the package member 40. After that, the opening of the package member 40 is sealed by thermal fusion bonding or the like. Finally, the resultant is heated while a weight is applied to the package member 40, and the separator 35 is contacted to the cathode 33 and the anode 34 with the polymer compound in between. Thereby, the electrolytic solution is impregnated into the polymer compound, and the polymer compound is gelated to form the electrolyte 36. Accordingly, the secondary battery is completed. In the third manufacturing method, the swollenness characteristics are improved compared to the first manufacturing method. Further, in the third manufacturing method, the monomer as a raw material of the polymer compound, the solvent and the like hardly remain in the electrolyte 36 compared to in the second manufacturing method, and the steps of forming the polymer compound are favorably controlled. Thus, sufficient contact characteristics are obtained between the cathode 33/the anode 34/the separator 35 and the electrolyte 36.

In the secondary battery, in the same manner as that of the first battery, lithium ions are inserted and extracted between the cathode 33 and the anode 34. That is, when charged, for example, lithium ions are extracted from the cathode 33 and inserted in the anode 34 through the electrolyte 36. Meanwhile, when discharged, lithium ions are extracted from the anode 34, and inserted in the cathode 33 through the electrolyte 36.

Actions and effects of the secondary battery and the method of manufacturing the secondary battery are similar to those of the foregoing first battery.

### Third Battery

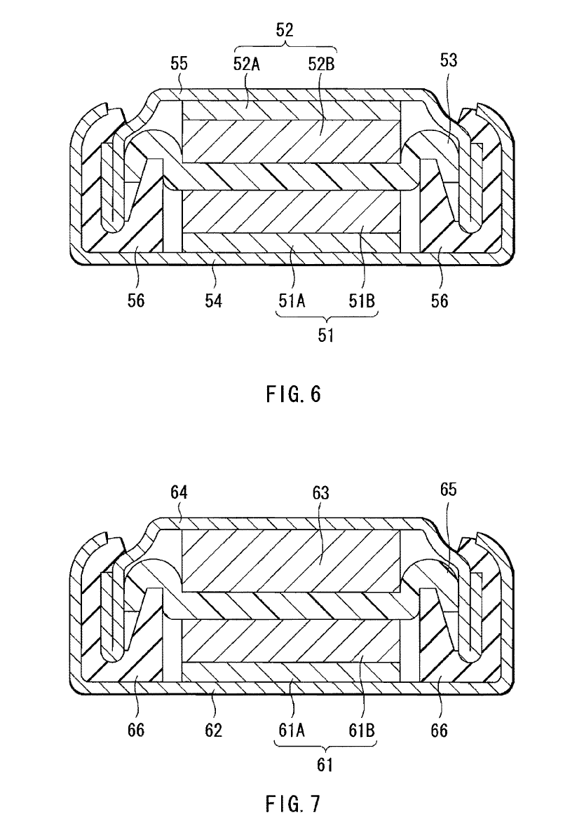

FIG. 6 illustrates an exploded perspective structure of a third battery. In the battery, a cathode 51 is bonded to a package can 54 and an anode 52 is contained in a package cup 55, the resultant is layered with a separator 53 impregnated with an electrolytic solution in between, and the resultant laminated body is caulked with a gasket 56. The battery structure using the package can 54 and the package cup 55 is so-called coin type.

The cathode 51 has a structure in which a cathode active material layer 51B is provided on a single face of a cathode current collector 51A. The anode 52 has a structure in which an anode active material layer 52B and a coat 52C are provided on a single face of an anode current collector 52A. Structures of the cathode current collector 51A, the cathode active material layer 51B, the anode current collector 52A, the anode active material layer 52B, and the separator 53 are respectively similar to those of the cathode current collector 21A, the cathode active material layer 21B, the anode current collector 22A, the anode active material layer 22B, and the separator 23 in the foregoing first battery.

In the secondary battery, in the same manner as that of the first battery, lithium ions are inserted and extracted between the cathode 51 and the anode 52. That is, when charged, for example, lithium ions are extracted from the cathode 51 and inserted in the anode 52 through the electrolytic solution. Meanwhile, when discharged, lithium ions are extracted from the anode 52, and inserted in the cathode 51 through the electrolytic solution.

Actions and effects of the coin-type secondary battery and the method of manufacturing the coin-type secondary battery are similar to those of the foregoing first battery.

### EXAMPLES

A description will be given in detail of specific examples of the invention.

### Example 1

First, a mesophase graphite spherule in which the ratio of the outer surface area to the entire surface area obtained by as plot analysis of an adsorption isotherm by nitrogen absorption measurement was 16%, the median diameter (D₅₀) by laser diffractive particle size distribution meter was 30 μm, and the specific area determined by BET method based on nitrogen absorption measurement was 1.6 m²/g was prepared. The nitrogen absorption measurement was performed by a fully automatic gas absorption equipment (OMNISORP 100CX of Beckman Coulter Inc.), and thereby the adsorption isotherm of the mesophase graphite spherule at 77K was obtained.

Next, an electrode containing the foregoing mesophase graphite spherule as an active material was formed. Specifically, first, 90 parts by mass of the foregoing mesophase graphite spherule and 10 parts by mass of polyvinylidene fluoride as a binder were mixed. Then, the resultant mixture was dispersed in N-methyl-2-pyrrolidone (NMP) as a solvent to obtain mixture slurry. Next, a current collector made of a copper foil being 12 μm thick was uniformly coated with the mixture slurry, which was dried. The resultant was compression-molded so that the volume density became 1.80 g/cm³ to form an active material layer. After that, the current collector provided with the active material layer was punched out into a pellet having a diameter of 16 mm to obtain an electrode. The area density of the active material layer to the area of the current collector was 12 mg/cm².

Next, with the use of the electrode, a coin-type test cell in a diameter of 20 mm, and a thickness of 1.6 mm having the structure illustrated in FIG. 7 was formed. In the test cell, the foregoing electrode obtained as a pellet having a diameter of 16 mm was used as a test electrode 61, the test electrode 61 was contained in a package can 62, a counter electrode 63 was bonded to a package cup 64, and the resultant was layered with a separator 65 impregnated with an electrolytic solution in between, and then the resultant laminated body was caulked with a gasket 66. That is, in the test electrode 61, an active material layer 61B containing the foregoing mesophase graphite spherule as an active material was provided on a current collector 61A made of a copper foil, and the active material layer 61B was arranged oppositely to the counter electrode 63 with the separator 65 in between. In that case, lithium metal was used as the counter electrode 63, a polyethylene porous film was used as the separator 65, and a solution containing a mixed solvent obtained by mixing ethylene carbonate (EC) and diethyl carbonate (DEC) at a volume ratio of 1:1 and LiPF₆ as an electrolyte salt was used as an electrolytic solution. The concentration of lithium hexafluorophosphate in the electrolytic solution was 1 mol/dm³.

### Examples 2 to 5

Test cells as illustrated in FIG. 7 were formed in the same manner as that of Example 1, except that the ratio of the outer surface area to the entire surface area in the mesophase graphite spherule, the median diameter D₅₀, and the specific surface area were respectively changed as shown in the following Table 1.

Further, as Comparative examples 1 to 5 relative to Examples 1 to 5, test cells as illustrated in FIG. 7 were formed in the same manner as that of Example 1, except that the ratio of the outer surface area to the entire surface area in the mesophase graphite spherule, the median diameter D₅₀, and the specific surface area were respectively changed as shown in the following Table 1.

For the respective test cells of Examples 1 to 5 and Comparative examples 1 to 5 formed as above, the relative press pressure, the discharge capacity, the discharge capacity retention ratio, and damage to the current collector of the electrode were evaluated. The results are shown in Table 1 all together.

The relative press pressure was obtained by measuring the press pressure necessary in the case where the active material layer was compression-molded so that the volume density became 1.80 g/cm³, and normalizing the results based on the press pressure of Comparative example 1 for the electrodes of the respective examples and the respective comparative examples.

The discharge capacity was obtained as follows. First, for each test cell, constant current charge was performed at a constant current of 0.1 C until the equilibrium potential reached 5 mV to lithium. Further, constant voltage charge was performed at a constant voltage of 5 mV until the total time from starting the constant current charge reached 20 hours. After that, discharge was performed at a constant current of 0.1 C until the equilibrium potential reached 1.5 V to lithium, and the discharge capacity (mAh/g) then was measured. 0.1 C is a current value at which the theoretical capacity is completely charged in 10 hours. The discharge capacity calculated as above was based on the equilibrium potential, and thus the discharge capacity reflected characteristics inherent to the material composing the active material layer of the test electrode 61.

Further, the discharge capacity retention ratio associated with progress of charge and discharge cycle was obtained as follows. Under the charge conditions and the discharge conditions described above, each test cell was repeatedly charged and discharged. The discharge capacity at the first cycle and the discharge capacity at the 50th cycle were respectively measured. Then, discharge capacity retention ratio (%)=(discharge capacity at the 50th cycle/discharge capacity at the first cycle)×100 was calculated.

The damage to the current collector of the electrode was evaluated as follows. Once the electrode in which the active material layer was formed was dipped in an organic solvent and washed, and thereby the active material layer was peeled from the current collector. The resultant was dried, and then the current collector was visually observed by an optical microscope with 100-power magnifications. For the visual observation, arbitrary 3 locations of a square region having each side of 5 mm on the electrode surface were selected. Then, the number of dents resulting from the mesophase graphite spherule generated on the current collector caused by pressure in press molding was counted. Out of circular or oval dents generated on the current collector surface caused by pressure against the current collector surface by the spherical mesophase graphite spherule, the number of dents in which the smallest dimension was in the range from 3 to 70 μm was counted. Further, in the case where two or more dents were overlapped at the same location, separation was made by visual observation, and the number of overlapped dents were determined and counted. Table 1 shows the number of dents of the examples and the comparative examples other than Comparative example 1 that was normalized where the number of dents in Comparative example 1 was the reference value 100.

TABLE 1
Anode active material layer: Volume density: 1.80 g/cm³

| | Outer surface | Median | Specific | Press | Discharge | Discharge | Number |
|---|---|---|---|---|---|---|---|
| | area/entire | diameter | surface area | pressure | capacity | capacity | of dents |
| | surface area % | D₅₀ μm | m²/g | (relative value) | mAh/g | retention ratio % | (relative value) |
| Example 1 | 16 | 30 | 1.6 | 0.86 | 356 | 92.4 | 85 |
| Example 2 | 20 | 28 | 1.8 | 0.49 | 356 | 92.6 | 44 |
| Example 3 | 24 | 32 | 1.4 | 0.65 | 355 | 92.9 | 50 |
| Example 4 | 32 | 30 | 1.2 | 0.76 | 350 | 92.7 | 58 |
| Example 5 | 48 | 15 | 1.8 | 0.82 | 349 | 92.8 | 78 |
| Comparative | 4 | 31 | 1.6 | 1 | 354 | 92.7 | 100 |
| example 1 | | | | | | | |
| Comparative | 6 | 25 | 1.5 | 0.95 | 349 | 92.5 | 94 |
| example 2 | | | | | | | |
| Comparative | 8 | 32 | 0.9 | 0.91 | 348 | 92.2 | 93 |
| example 3 | | | | | | | |
| Comparative | 53 | 30 | 1.2 | 0.36 | 337 | 82.4 | 40 |
| example 4 | | | | | | | |
| Comparative | 67 | 34 | 1.8 | 0.28 | 331 | 79.1 | 36 |
| example 5 | | | | | | | |

As shown in Table 1, in Examples 1 to 5, the mesophase graphite spherule in which the ratio of the outer surface area to the entire surface area was in the range from 10% to 50%, both inclusive, the specific area was in the range from 0.1 m²/g to 5 m²/g, both inclusive, and the median diameter (D₅₀) was in the range from 5 μm to 50 μm, both inclusive was used as an active material. Thus, the relative press pressure was lower (0.49 to 0.86) than the relative press pressure (0.91 to 1) of Comparative examples 1 to 3 using the mesophase graphite spherule in which the ratio of the outer surface area to the entire surface area was under 10% as an active material, and thus it was found that the press characteristics were improved. Accordingly, in Examples 1 to 5, the number of dents of the current collector was largely decreased than that of Comparative examples 1 to 3. Further, in Examples 1 to 5, the discharge capacity was in the range from 349 mAh/g to 356 mAh/g, both inclusive, and the discharge capacity retention ratio was in the range from 92.4% to 92.9%, both inclusive, and thus it was found that the discharge capacity and the discharge capacity retention ratio almost equal to those of Comparative examples 1 to 3 were maintained.

Further, in Examples 1 to 5, the relative press pressure was higher than that of Comparative examples 4 and 5 using, as an active material, the mesophase graphite spherule in which the ratio of the outer surface area to the entire surface area exceeded 50%, but the discharge capacity and the discharge capacity retention ratio were largely increased.

The invention has been described with reference to the embodiment and the examples. However, the invention is not limited to the embodiment and the examples, and various modifications may be made. For example, in the foregoing embodiment and the foregoing examples, the description has been given of the battery using lithium as an electrode reactant. However, the invention is applicable to a case using other alkali metal such as sodium (Na) and potassium (K), an alkali earth metal such as magnesium and calcium (Ca), or other light metal such as aluminum. In this case, a cathode active material capable of inserting and extracting an electrode reactant and the like are selected according to the electrode reactant.

Further, in the foregoing embodiment and the foregoing examples, the descriptions have been given with the specific examples of the batteries including the battery element having the cylindrical or flat (oval) spirally wound structure and the coin type battery. However, the invention is similarly applicable to a battery including a battery element having a polygonal spirally wound structure, a battery having a structure in which a cathode and an anode are folded, or a battery including a battery element having other structure such as a structure in which a plurality of cathodes and a plurality of anodes are layered. In addition, the invention is similarly applicable to a battery having other package shape such as a square type battery.

Further, in the foregoing embodiment and the foregoing examples, the descriptions have been given of the case using the electrolytic solution or the gel electrolyte in which the electrolytic solution is held by the polymer compound as an electrolyte. However, other electrolyte may be used by mixture. As other electrolyte, for example, an organic solid electrolyte obtained by dissolving or dispersing an electrolyte salt into a polymer compound having ion conductivity, an inorganic solid electrolyte containing an ion conductive inorganic compound such as ion conductive ceramics, ion conductive glass, and ionic crystal are included.

It should be understood by those skilled in the art that various modifications, combinations, sub-combinations and alternations may occur depending on design requirements and other factors insofar as they are within the scope of the appended claims or the equivalents thereof.

What is claimed is:

1. An anode active material containing a spherocrystal graphitized substance of mesophase spherule provided with a fine pore as defined by International Union of Pure and Applied Chemistry.

2. The anode active material according to claim 1, wherein in the spherocrystal graphitized substance of mesophase spherule, a ratio of an outer surface area to an entire surface area is in the range from 10% to 50%, both inclusive.

3. The anode active material according to claim 1, wherein in the spherocrystal graphitized substance of mesophase spherule, a specific surface area determined by BET method based on nitrogen absorption measurement is in the range from 0.1 m²/g to 5 m²/g, both inclusive.

4. The anode active material according to claim 1, wherein in the spherocrystal graphitized substance of mesophase spherule, a median diameter (D₅₀) by laser diffractive particle size distribution meter is in the range from 5 μm to 50 μm, both inclusive.

5. The anode active material according to claim 1, wherein in the spherocrystal graphitized substance of mesophase spherule, lattice spacing d₀₀₂ in a C-axis direction calculated by X-ray wide angle diffraction method is in the range from 0.3354 nm to 0.3370 nm, both inclusive, and crystallite size in the C-axis direction is 80 nm or more.

6. The anode active material according to claim 1, wherein in the spherocrystal graphitized substance of mesophase spherule, raman spectrum using argon ion laser light satisfies the following condition expression:
0.05≦B/A≦0.2
where A is an intensity of a peak observed in the range from 1570 cm⁻¹ to 1620 cm⁻¹, both inclusive, and B is an intensity of a peak observed in the range from 1350 cm⁻¹ to 1370 cm⁻¹, both inclusive.

7. An anode having an anode active material layer provided on an anode current collector, wherein the anode active material layer contains a spherocrystal graphitized substance of mesophase spherule provided with a fine pore as an anode active material.

8. The anode according to claim 7, wherein in the spherocrystal graphitized substance of mesophase spherule, a ratio of an outer surface area to an entire surface area is in the range from 10% to 50%, both inclusive.

9. The anode according to claim 7, wherein in the spherocrystal graphitized substance of mesophase spherule, a specific surface area determined by BET method based on nitrogen absorption measurement is in the range from 0.1 m²/g to 5 m²/g, both inclusive.

10. The anode according to claim 7, wherein in the spherocrystal graphitized substance of mesophase spherule, a median diameter (D₅₀) by laser diffractive particle size distribution meter is in the range from 5 μm to 50 μm, both inclusive.

11. The anode according to claim 7, wherein in the spherocrystal graphitized substance of mesophase spherule, lattice spacing d₀₀₂ in a C-axis direction calculated by X-ray wide angle diffraction method is in the range from 0.3354 nm to 0.3370 nm, both inclusive, and crystallite size in the C-axis direction is 80 nm or more.

12. The anode according to claim 7, wherein in the spherocrystal graphitized substance of mesophase spherule, raman spectrum using argon ion laser light satisfies the following condition expression:
0.05≦B/A≦0.2
where A is an intensity of a peak observed in the range from 1570 cm⁻¹ to 1620 cm⁻¹, both inclusive, and B is an intensity of a peak observed in the range from 1350 cm⁻¹ to 1370 cm⁻¹, both inclusive.

13. The anode according to claim 7, wherein a volume density of the anode active material layer is in the range from 1.50 g/cm³ to 2.26 g/cm³, both inclusive.

14. A battery comprising:
a cathode;
an anode; and
an electrolyte,
wherein,
the anode has an anode active material layer provided on an anode current collector, and
the anode active material layer contains a spherocrystal graphitized substance of mesophase spherule provided with a fine pore as an anode active material.

15. A method of manufacturing an anode comprising the steps of:
preparing an anode current collector, and then forming an anode active material layer containing a spherocrystal graphitized substance of mesophase spherule provided with a fine pore on the anode current collector; and
press-molding the anode active material layer so that a volume density thereof is in the range from 1.50 g/cm³ to 2.26 g/cm³, both inclusive.
